(19) United States
(12) Patent Application Publication
(10) Pub. No.: US 2025/0219204 A1
(43) Pub. Date: Jul. 3, 2025

(54) PACKAGING MATERIAL FOR POWER STORAGE DEVICE, SEALANT FILM, PACKAGING CASE FOR POWER STORAGE DEVICE AND POWER STORAGE DEVICE

(71) Applicant: Resonac Packaging Corporation, Hikone-shi (JP)

(72) Inventors: Yuji MINAMIBORI, Hikone-shi (JP); Tatsuru KUROIWA, Hikone-shi (JP)

(21) Appl. No.: 19/002,521

(22) Filed: Dec. 26, 2024

(30) Foreign Application Priority Data
Dec. 27, 2023 (JP) 2023-221935

(51) Int. Cl. H01M 50/129; H01G 11/80; H01M 50/121; H01M 50/122

(52) U.S. Cl. CPC H01M 50/129; H01M 50/121; H01M 50/122; H01G 11/80

(57) ABSTRACT

A packaging material for a power storage device includes a base layer, a barrier layer, and a sealant layer, the sealant layer includes an A layer, a B layer and a C layer, the A layer contains a propylene resin A, which is a random copolymer of propylene and another copolymer component except for propylene, the B layer contains a propylene resin B including a rubber phase, which is a copolymer of ethylene and an α-olefin having 3 to 10 carbon atoms, the C layer contains a propylene resin C, which is a random copolymer of propylene and another copolymer component except for propylene, a content rate of the rubber phase in the propylene resin B is from 20% by mass to 40% by mass, and the C layer further includes incompatible particles, and a content rate of the incompatible particles is from 1000 ppm to 4000 ppm.

### CROSS-REFERENCE TO RELATED APPLICATION

This application claims priority under 35 USC 119 from Japanese Patent Application No. 2023-221935 filed on Dec. 27, 2023 the disclosure of which is incorporated by reference herein.

All publications, patent applications, and technical standards mentioned in this specification are herein incorporated by reference to the same extent as if each individual publication, patent application, or technical standard was specifically and individually indicated to be incorporated by reference.

### TECHNICAL FIELD

The present invention relates to a packaging material for a power storage device, a sealant film, a packaging case for a power storage device and a power storage device.

In recent years, as mobile electrical devices such as smartphones and tablet terminals become thinner and lighter, a layered body consisting of a heat-resistant resin layer/adhesive layer/metal foil layer/adhesive layer/thermoplastic resin layer (inner sealant layer) instead of a conventional metal can is used as the packaging material of a power storage device such as a lithium ion secondary battery, a lithium polymer secondary battery, a lithium ion capacitor, and an electric double layer capacitor mounted thereon. In addition, power sources for electric vehicles, large power sources for power storage, capacitors, or the like is increasingly being exteriorized with a layered body (packaging material) of the above configuration. The layered body is molded into a three-dimensional shape such as a substantially rectangular parallelepiped shape by performing stretch molding or deep drawing. By molding into such a three-dimensional shape, a storage space for accommodating a power storage device body portion can be secured.

In order to form such a three-dimensional shape in a good condition without pinholes, breaks, or the like, it is necessary to improve the slipperiness of the surface of the inner sealant layer. Examples of a method for improving the slipperiness of the surface of the inner sealant layer is to add an antiblocking agent to the inner sealant layer. However, if an excessive amount of the antiblocking agent is added to the inner sealant layer, the inner sealant layer is likely to become cloudy, and the clouding of the sealant layer causes a problem that delamination occurring in the packaging material is likely to be overlooked during quality inspection.

Patent Document 1 proposes a packaging material for a power storage device that can ensure good slip properties during molding, thereby ensuring good moldability, and can also suppress clouding in the packaging material.

### CITATION LIST

### Patent Literature

Patent Literature 1: Japanese Patent No. 6936093

### SUMMARY OF INVENTION

### Technical Problem

For example, a power storage device is obtained by joining the inner sealant layer by heat sealing in the state that a power storage device body portion has been accommodated in a packaging case obtained by molding a packaging material for a power storage device as described in Patent Document 1. In a power storage device, an electrolyte solution with a high ratio of a low-viscosity solvent is sometimes used to improve rapid charging. A low-viscosity solvent have high permeability into a sealant layer, and the degree of swelling of the sealant layer increases. As a result, the seal strength of the heat-sealed portion may decrease, and the reliability of the heat seal may decrease.

Furthermore, when the electrolyte solution permeates into the sealant layer, air bubbles are likely to occur in the heat-sealed portion due to evaporation of the electrolyte solution or the like, which may cause deterioration in the appearance of the heat-sealed portion and a decrease in the reliability of the heat seal.

From the above point, a packaging material for a power storage device, which has high seal strength and is capable of suppressing air bubbles, is required.

The object of the present disclosure is to provide a packaging material for a power storage device, which has a high seal strength and is capable of suppressing air bubbles, and a sealant film, and a packaging case for a power storage device and a power storage which uses this packaging material for a power storage device.

### Solution to Problem

Specific means for addressing the above problem include the following aspects.

<1> A packaging material for a power storage device including a base layer, a barrier layer, and a sealant layer configured to be layered in this order,
wherein the sealant layer includes an A layer, a B layer and a C layer when viewed from the base layer side,
wherein the A layer contains a propylene resin A, which is a random copolymer of propylene and another copolymer component except for propylene, as a main component,
wherein the B layer contains a propylene resin B including a rubber phase, which is a copolymer of ethylene and an α-olefin having 3 to 10 carbon atoms, as a main component,
wherein the C layer contains a propylene resin C, which is a random copolymer of propylene and another copolymer component except for propylene, as a main component,
wherein a content rate of the rubber phase in the propylene resin B is from 20% by mass to 40% by mass, and
wherein the C layer further contains incompatible particles, and a content rate of the incompatible particles in the C layer is from 1000 ppm to 4000 ppm.
   <2> The packaging material for a power storage device according to <1>, wherein a ratio of a thickness of the B layer with respect to a thickness of the sealant layer is 50% or more.
   <3> The packaging material for a power storage device according to <1> or <2>, wherein the incompatible particles includes silica particles.
   <4> A sealant film, including an A layer, a B layer and a C layer in this order,
wherein the A layer contains a propylene resin A, which is a random copolymer of propylene and another copolymer component except for propylene, as a main component,
wherein the B layer contains a propylene resin B including a rubber phase, which is a copolymer of ethylene and an α-olefin having 3 to 10 carbon atoms, as a main component,
wherein the C layer contains a propylene resin C, which is a random copolymer of propylene and another copolymer component except for propylene, as a main component,
wherein a content rate of the rubber phase in the propylene resin B is from 20% by mass to 40% by mass, and
wherein the C layer further contains incompatible particles, and a content rate of the incompatible particles in the C layer is from 1000 ppm to 4000 ppm.
   <5> The sealant film according to <4> used for a manufacture of a packaging material for a power storage device.
   <6> A packaging case for a power storage device including a molded product of the packaging material for a power storage device according to any one of <1> to <3>.
   <7> A power storage device including:
a power storage device body portion, and
a packaging member including the packaging material for a power storage device according to any of <1> to <3>, which accommodate the power storage device body portion.

### Advantageous Effects of Invention

According to the present disclosure, a packaging material for a power storage device, which has a high seal strength and is capable of suppressing air bubbles, and a sealant film, and a packaging case for a power storage device and a power storage which uses this packaging material for a power storage device can be provided.

### BRIEF DESCRIPTION OF DRAWINGS

FIG. 1 is a schematic cross-sectional view showing an example of a packaging material for a power storage device of the present disclosure.

FIG. 2 is a schematic cross-sectional view showing an example of a power storage device.

FIG. 3 is a schematic perspective view showing that each component configuring the power storage device in FIG. 2 has been separated.

### DESCRIPTION OF EMBODIMENTS

Hereinafter, the present disclosure will be described in detail. However, the present disclosure is not limited to the following embodiments. In the following embodiments, the constituent elements (including element steps and the like) are not essential unless otherwise specified. The same applies to numerical values and ranges thereof, and does not limit the present disclosure.

In the present disclosure, the term “step” includes, in addition to steps independent of other steps, such steps as long as the purpose of the step is achieved even if it cannot be clearly distinguished from other steps.

In the present disclosure, those numerical ranges that are expressed with “to” each denote a range that includes the numerical values stated before and after “to” as the minimum value and the maximum value, respectively.

In a set of numerical ranges that are stated stepwise in the present disclosure, the upper limit value or the lower limit value of a numerical range may be replaced with the upper limit value or the lower limit value of other numerical range. Further, in a numerical range stated in the present disclosure, the upper limit value or the lower limit value of the numerical range may be replaced with a value indicated in Examples.

In the present disclosure, each component may contain plural kinds of substances that correspond to the indicated component. In a case in which there are plural kinds of substances that correspond to the component in a composition, the indicated content ratio or content of the component in the composition means, unless otherwise specified, the total content ratio or content of the plural kinds of substances existing in the composition.

In the present disclosure, each component may contain plural kinds of particles that correspond to the indicated component. In a case in which there are plural kinds of particles that correspond to the component in a composition, the indicated particle size of the component in the composition means, unless otherwise specified, a value determined for a mixture of the plural kinds of particles existing in the composition.

In the present disclosure, the term “layer” or “film” includes, in addition to the case where the region is entirely formed, that when the region where the layer or the film is present is observed, it is formed in only a part of the region.

### <Packaging Material for Power Storage Device>

### First Embodiment

In a packaging material for a power storage device (hereinafter, simply also referred to as “packaging material”), a base layer, a barrier layer, and a sealant layer is layered in this order, the sealant layer includes an A layer, a B layer and a C layer when viewed from the base layer side, the A layer contains a propylene resin A, which is a random copolymer of propylene and another copolymer component except for propylene, as a main component, the B layer contains a propylene resin B including a rubber phase, which is a copolymer of ethylene and an α-olefin having 3 to 10 carbon atoms, as a main component, the C layer contains a propylene resin C, which is a random copolymer of propylene and another copolymer component except for propylene, as a main component, a content rate of the rubber phase in the propylene resin B is from 20% by mass to 40% by mass, and the C layer further contains incompatible particles, and a content rate of the incompatible particles in the C layer is from 1000 ppm to 4000 ppm.

The packaging material for a power storage device has a high seal strength and is capable of suppressing air bubbles. In the packaging material for a power storage device, when a content rate of the rubber phase in the propylene resin B is 20% by mass or more, a seal strength of the sealant layer can be improved. When the content rate of the rubber phase in the propylene resin B is 40% by mass or less and a content rate of the incompatible particles in the C layer is 1000 ppm or more, there is a tendency that an excessive penetration of an electrolyte solution can be suppressed when a low-viscosity solvent is used as the electrolyte solution. As a result, an occurrence of air bubbles can be suppressed. When the content rate of the incompatible particles in the C layer is 4000 ppm or less, an amount of the electrolyte solution which is absorbed on the incompatible particles can be reduced, and as a result, an occurrence of air bubbles can be suppressed.

The packaging material for a power storage device of the present disclosure is preferably used as the manufacture of a power storage device accommodating a power storage device body portion, which corresponds to charging with an electric power of 18 W or more. Thus, in order to achieve rapid charging, it is desirable to use an electrolyte solution having a high ratio of a low-viscosity solvent. When the electrolyte solution is used, a low-viscosity solvent has high permeability to a sealant layer, and thereby a seal strength of a heat-sealed portion is decreased, or air bubbles due to evaporation of the electrolyte solution or the like are likely to generate. On the other hand, the packaging material for a power storage device of the present disclosure has a high seal strength and is capable of suppressing air bubbles, and thereby rapid charging with a power storage device is possible.

A layer structure of a packaging material for a power storage device will be described below.

### (Base Layer)

The packaging material for a power storage device includes a base layer.

The base layer is preferably formed by a heat-resistant resin layer. The heat-resistant resin is preferably a resin, which does not melt at heat seal temperature when heat sealing a packaging material. The heat-resistant resin is preferably a resin having a high melting point, for example, the resin preferably has a melting point higher than each layer included in the sealant layer, and the resin preferably has a melting point higher than the highest melting point among each layer included in the sealant layer by 10° C. or more, or the resin preferably has a melting point higher than the highest melting point among each layer included in the sealant layer by 20° C. or more.

Examples of the base layer include a polyamide film such as a nylon film, a polyester film, or the like, and these films may be stretched films. Examples of the stretched film include a biaxially stretched polyamide film such as a biaxially stretched nylon film, a biaxially stretched polybutylene terephthalate (PBT) film, a biaxially stretched polyethylene terephthalate (PET) film, a biaxially stretched polyethylene naphthalate (PEN) film, or the like. Examples of the nylon film include a nylon 6 film, a nylon 6, 6 film, or a MXD nylon film.

The base layer may be a single layer, or may be a multilayer consisted of two or more layer. Examples of the multilayer include a polyester film/poly amide film (for example, PET film/nylon film).

A thickness of the base layer may be from 2 μm to 50 μm. For example, when the base layer is a polyester film, the thickness may be from 2 μm to 50 μm or when the base layer is a nylon film, the thickness may be from 7 μm to 50 μm.

### (Outer Adhesive Layer)

An adhesive layer (also referred to as “outer adhesive layer”) is disposed between the base layer and a barrier layer which is described above, or the base layer and the barrier layer is integrated via the outer adhesive layer.

Examples of adhesive configuring the outer adhesive layer are not particular limited and example thereof include a thermosetting adhesive and the like. Examples of the thermosetting adhesive are not particular limited and example thereof include an olefin-based adhesive, an epoxy-based adhesive, an acrylic-based adhesive and the like. A thickness of the outer adhesive layer may be from 1 μm to 5 μm. In particular, from the viewpoint of making the packaging material thinner and lighter, the thickness of the outer adhesive layer is preferably from 1 μm to 3 μm.

The outer adhesive layer may be a single layer or may be a multilayer having two or more layer. When it is a multilayer, it may be a combination of an adhesive layer containing a colorant and an adhesive layer not containing a colorant.

### (Barrier Layer)

The packaging material for a power storage device includes a barrier layer.

The barrier layer takes on a role of imparting gas barrier properties to the packaging material to suppress the intrusion of oxygen, moisture, or the like. The barrier layer is not particularly limited, and examples thereof include a metal foil, a vapor deposition film, a resin layer, and the like. Examples of the vapor deposition film include a metal vapor deposition film, an inorganic oxide vapor deposition film, a carbon-containing inorganic oxide vapor deposition film, and the like. Examples of the metal foil are not particularly limited, and examples thereof include an aluminum foil, a SUS foil (stainless steel foil), a Cu foil, a Ni foil, a Ti foil, and the like. Among them, an aluminum foil and a SUS foil (stainless steel foil) are preferable. Examples of a resin used in the resin layer include a fluorine-containing resin, an ethylene-vinyl alcohol copolymer, and the like. Examples of the fluorine-containing resin include polyvinylidene chloride, polymers mainly composed of chlorotrifluoroethylene (CTFE), polymers mainly composed of tetrafluoroethylene (TFE), polymers having a fluoroalkyl group, polymers mainly composed of a fluoroalkyl unit, and the like.

The barrier layer may be a single layer or a multilayer having two or more layers. When it is a multilayer, it may be a layered body of the same layers, or may be a layered body of different layers. Examples of different layers include a combination of a vapor deposition film and a resin layer.

From the view point of suppression of pinholes during rolling and moldability, a thickness of the barrier layer may be from 5 μm to 120 μm, or may be from 10 μm to 80 μm.

In the metal foil, a chemical conversion treatment is executed on at least one of a surface of the base layer side and a surface of the adhesive layer side, and for example, the metal foil may have a corrosion protection layer. By disposing the corrosion protection layer, it is possible to suppress corrosion of the metal foil surface caused by a content (such as electrolyte solution in battery). For example, the metal foil may be subjected to a chemical conversion treatment to form a corrosion protection layer by carrying out the following treatment.

For example, one of the following solutions 1) to 3) was applied onto the surface of the metal foil to which a degreasing treatment was performed, and then dried to execute a chemical conversion treatment:
1) an aqueous solution of a mixture containing phosphoric acid,
   chromic acid, and
   at least one kind of compounds selected from the group consisting of metal salt of fluoride and non-metallic salt of fluoride
2) an aqueous solution of a mixture containing phosphoric acid,
   at least one kind of resins selected from the group consisting of an acrylic based resin, a chitosan derivative resin, and a phenol based resin, and
   at least one kind of compounds selected from the group consisting of chromic acid and a chromium (III) salt
3) an aqueous solution of a mixture containing phosphoric acid,
   at least one kind of resin selected from the group consisting of an acrylic based resin, a chitosan derivative resin, and a phenol based resin,
   at least one kind of compound selected from the group consisting of chromic acid and a chromium (III) salt, and
   at least one kind of compound selected from the group consisting of a metal salt of fluoride and a non-metallic salt of fluoride.

In a chemical conversion film formed by the chemical conversion treatment, a chromium deposition amount (per one surface) is preferably from 0.1 mg/m² to 50 mg/m², and more preferably from 2 mg/m² to 20 mg/m².

### (Inner Adhesive Layer)

An adhesive layer (also referred to as “inner adhesive layer”) is disposed between the barrier layer and a sealant layer which is described above, or the barrier layer and the sealant layer is integrated via the inner adhesive layer.

Examples of adhesive configuring the inner adhesive layer are not particular limited and example thereof include a thermosetting adhesive and the like. Examples of the thermosetting adhesive are not particular limited and example thereof include an olefin-based adhesive, an epoxy-based adhesive, an acrylic-based adhesive and the like. A thickness of the inner adhesive layer may be from 1 μm to 5 μm. In particular, from the viewpoint of making the packaging material thinner and lighter, the thickness of the inner adhesive layer is preferably from 1 μm to 3 μm.

### (Sealant Layer)

The packaging material for a power storage device include a sealant layer. The sealant layer is a layer taking on a role of imparting heat seal property to the packaging material. The sealant layer includes an A layer, a B layer and a C layer in this order when viewed from the base layer side. Therefore, the layers are disposed in the order of a base layer, a barrier layer, an adhesive layer, an A layer, a B layer and a C layer. The sealant layer may include or may not include a layer other than an A layer, a B layer or a C layer.

### <A Layer>

An A layer contains a propylene resin A, which is a random copolymer of propylene and another copolymer component except for propylene, as a main component.

In the present disclosure, “contain . . . as a main component” means the proportion of the corresponding component in each layer is the highest, and for example, it means that a content rate of the corresponding component is 50% by mass or more with respect to a total of the layer.

A MFR of the propylene resin A may be 10 g/10 min or more, may be from 10 g/10 min to 25 g/10 min, or may be from 12 g/10 min to 20 g/10 min.

In the present disclosure, a MFR means a MFR (melt flow rate) measured under the condition of a temperature of 230° C. and a load of 2.16 kg in accordance with JIS K7210-1999.

A melting point of the propylene resin A may be not less than 140° C. and less than 170° C., may be from 140° C. to 165° C., or may be from 140° C. to 155° C.

In the present disclosure, a melting point means a melting peak temperature (melting point) measured under the condition of a heating rate of 10° C./min using a differential scanning calorimeter by the method specified in JIS K7121-1987 “Method of measuring transition temperature of plastics”.

The propylene resin A is a random copolymer of propylene and another copolymer component except for propylene, is preferably a random copolymer of propylene and a monomer at least one selected from the group consisting of ethylene and an α-olefin having 4 or more carbon atoms. Examples of another copolymer component except for propylene include ethylene, an α-olefin having 4 or more carbon atoms, butadiene and the like. Examples of an α-olefin having 4 or more carbon atoms include ethylene, 1-butene, 1-hexene, 1-pentene, 4-methyl-1-pentene and the like.

Among the resin component contained in the A layer, a content rate of the propylene resin A is preferably 50% by mass or more, more preferably 60% by mass or more, still more preferably 70% by mass or more, particularly preferably 80% by mass or more, extremely preferably 90% by mass or more, may be 95% by mass or more, or may be 99% by mass or more.

The upper limit of the aforementioned content rate of the propylene resin A is not particularly limited and may be 100% by mass or less.

The A layer may contain a resin other than the propylene resin A (also referred to as “another resin”). Examples of another resin include an ethylene resin, an olefin-based resin, and the like.

A thickness of the A layer may be from 2 μm to 15 μm, or may be from 3 μm to 10 μm.

A ratio of a thickness of the A layer with respect to a thickness of the sealant layer may be 5% or more, may be 10% or more, may be 40% or less or may be 30% or less.

### <B Layer>

A B layer contains a propylene resin A, which is a random copolymer of propylene and another copolymer component except for propylene, as a main component. A content rate of a rubber phase in the propylene resin B is from 20% by mass to 40% by mass, and from the viewpoint of a heat seal strength, is preferably from 25% by mass to 40% by mass and is more preferably from 30% by mass to 40% by mass.

The rubber phase in the propylene resin B can be confirmed by observing a cross section of the sealant layer with a scanning electron microscope. For example, the content rate of the rubber phase in the propylene resin B can be determined by observing a sea portion mainly composed of polypropylene, and an island which is the rubber phase, and using an area ratio of the rubber phase and a density of a polymer configuring each of the sea portion and island portion.

A MFR of the propylene resin B may be from 1.0 g/10 min to 5.0 g/10 min, may be from 1.5 g/10 min to 5.0 g/10 min or may be from 2.0 g/10 min to 4.0 g/10 min.

A melting point of the propylene resin B may be 140° C. or more and less than 170° C., may be from 145° C. to 165° C., or may be from 150° C. to 165° C.

The propylene resin B is preferably a resin with a higher melting point more than the propylene resin A and propylene resin C described below. The melting point difference between the propylene resin C and propylene resin A may be from 1° C. to 30° C., may be from 5° C. to 30° C., or may be from 10° C. to 25° C.

The propylene resin B is a block copolymer of ethylene and an α-olefin having 3 to 10 carbon atoms, and is preferably a block copolymer of ethylene and propylene. Examples of the α-olefin having 3 to 10 carbon atoms include propylene, 1-butene, 1-hexene, 1-pentene, 4-methyl-1-pentene and the like.

When the propylene resin B is a block copolymer of ethylene and propylene, the propylene resin B includes a sea portion mainly composed of polypropylene and an island composed of an ethylene propylene rubber and the island corresponds to the rubber phase.

Among the resin component contained in the B layer, the content rate of the propylene resin B is preferably 50% by mass or more, more preferably 60% by mass or more, still more preferably 70% by mass or more, particularly preferably 80% by mass or more, extremely preferably 90% by mass or more, may be 95% by mass or more, may be 98% by mass or more, or may be 99% by mass or more.

The upper limit of the aforementioned content rate of the propylene B is not particularly limited and may be 100% by mass or less.

A thickness of the B layer may be 10 μm to 30 μm, or may be from 15 μm to 25 μm.

The ratio of the thickness of the B layer with respect to the thickness of the sealant layer may be 20% or more, may be 40% or more, may be 50% or more, may be 90% or less, may be 80% or less, or may be 70% or less.

### <C Layer>

A C layer includes a propylene resin C, which is a random copolymer of propylene and another copolymer component except for propylene, as a main component. The C layer further contains incompatible particles, and a content rate of the incompatible particles in the C layer is from 1000 ppm to 4000 ppm.

A MFR of the propylene resin C may be 10 g/10 min or more, may be from 10 g/10 min to 20 g/10 min, or may be from 10 g/10 min to 18 g/10 min.

The MFR of the propylene resin C is preferably not more than the MFR of the propylene resin A. Thereby, the fluidity of the layer A containing the propylene resin A is equal to or greater than the fluidity of the layer C containing the propylene resin C, and the fluidity of the sealant layer as a whole tends to be good.

The difference (MFR1−MFR2) between the MFR (MFR1) of the propylene A and the MFR (MFR2) of the propylene C may be from 0 g/10 min to 10 g/10 min, or may be from 0 g/10 min to 5 g/10 min.

A melting point of the propylene resin C may be from 100° C. to 140° C., may be from 110° C. to 140° C., or may be from 120° C. to 140° C.

The propylene resin C is a resin having a lower melting point than the propylene resin A and the melting point difference between the propylene resin A and the propylene resin C may be from 5° C. to 50° C., may be from 10° C. to 40° C., or may be from 12° C. to 30° C.

The propylene resin C is a random copolymer of propylene and another copolymer component except for propylene, and is preferably a random copolymer of propylene and a monomer at least one selected from the group consisting of ethylene and an α-olefin having 4 or more carbon atoms. Examples of another copolymer component except for propylene include ethylene, an α-olefin having 4 or more carbon atoms, butadiene and the like. Examples of an α-olefin having 4 or more carbon atoms include ethylene, 1-butene, 1-hexene, 1-pentene, 4-methyl-1-pentene and the like.

Among the resin component contained in the C layer, a content rate of the propylene resin C is preferably 50% by mass or more, more preferably 60% by mass or more, still more preferably 70% by mass or more, particularly preferably 80% by mass or more, extremely preferably 90% by mass or more, may be 95% by mass or more, may be 98% by mass or more, or may be 99% by mass or more.

The upper limit of the aforementioned content rate of the propylene resin C is not particularly limited and may be 100% by mass or less.

The C layer may contain a resin other than the propylene resin C (also referred to as “another resin”). Examples of another resin include an ethylene resin, an olefin-based resin, and the like.

A thickness of the C layer may be from 5 μm to 30 μm, or may be from 3 μm to 10 μm.

A ratio of a thickness of the C layer with respect to a thickness of the sealant layer may be 5% or more, may be 10% or more, may be 40% or less or may be 30% or less.

Propylene resin A and propylene resin C can be produced, for example, by reacting propylene with another copolymer component except for propylene in the presence of a metallocene catalyst. The MFR, melting point, or the like of the propylene resin A and propylene resin C can be adjusted by adjusting the reaction time, the amount of catalyst, the composition ratio of raw materials, or the like. For example, there is a tendency that the melting point of the resulting propylene resin tends to be lowered by increasing the ratio of another copolymer component except for propylene (for example, ethylene) with respect to propylene.

The A layer, B layer, C layer, and another layer which is disposed as necessary in the sealant layer may contain a component (another component) other than a resin such as a propylene resin.

Examples of another component include an antioxidant, a plasticizer, an ultraviolet absorber, an antifungal agent, a colorants (pigment, dye, or the like), an antistatic agent, a rust inhibitor, a moisture absorber, an oxygen absorber, and like. The plasticizer is not particularly limited and examples thereof include glycerin fatty acid ester monoglyceride, glycerin fatty acid ester acetylated monoglyceride, glycerin fatty acid ester organic acid monoglyceride, glycerin fatty acid ester medium chain fatty acid triglyceride, polyglycerin fatty acid ester, sorbitan fatty acid ester, propylene glycol fatty acid ester, special fatty acid ester, higher alcohol fatty acid ester, and the like.

The A layer, B layer, C layer, and another layer which is disposed as necessary in the sealant layer may further contain a lubricant.

The lubricant is not particularly limited and examples thereof include a fatty acid amide. The fatty acid amide is not particularly limited and examples thereof include a saturated fatty acid amide, an unsaturated fatty acid amide, a substituted amide, methylol amide, a saturated fatty acid bisamide, an unsaturated fatty acid bisamide, a fatty acid ester amide, an aromatic bisamide and the like.

The lubricant may or may not be contained in any layer of the sealant layer.

The C layer in the sealant layer contains incompatible particles. The A layer, B layer, C layer, and another layer which is disposed as necessary in the sealant layer may further contain the incompatible particles.

The incompatible particles may be inorganic particles, organic particles, metal particles, composite particles thereof and the like. From the viewpoint of suppressing deformation due to heat deformation by melting, the incompatible particles are preferably inorganic particles, metal particles or composite particles thereof, or from the viewpoint of ensuring the insulating function of the sealant layer and reducing weight, the incompatible particles are preferably inorganic particles, organic particles or composite particles thereof. From the viewpoint of overall perspectives, the incompatible particles more preferably includes inorganic particles.

The incompatible particles may be used alone or in combination of two or more kinds.

Examples of the inorganic particles include inorganic oxide particles (silica particles, alumina particles, titanium oxide particles, or the like), inorganic carbonate particles (calcium carbonate particles, barium carbonate particles, or the like), inorganic silicate particles (aluminum silicate particles, talc particles, kaolin particles, or the like), and the like. Among these, silica particles are preferable from the viewpoint of the balance between anti-blocking effect and bubble suppression.

Examples of the organic particles include acrylic resin particles, polyolefin resin particles (polyethylene resin particles, polypropylene resin particles, or the like), polystyrene resin particles and the like.

A content rate of the incompatible particles in the C layer is from 1000 ppm to 4000 ppm, is preferably from 1000 ppm to 3500 ppm, and is more preferably from 1000 ppm to 3000 ppm.

An average particle size of the incompatible particles may be from 0.1 μm to 4.5 μm, or may be from 0.5 μm to 4.5 μm. When the average particle size of the incompatible particles is 0.1 μm or more, there is a tendency that the function as an antiblocking agent is demonstrated, when the average particle size of the incompatible particles is 4.5 μm or less, there is a tendency that the occurrence of air bubbles due to evaporation of the electrolyte solution or the like can be suppressed.

The average particle size of the incompatible particles can also be measured by observing the cross-section of the sealant layer with a scanning electron microscope and measuring it. Specifically, the sealant layer is embedded in a transparent epoxy resin and polished with a polisher or slurry, or the like, and the cross-section of the sealant layer is observed and the particle size is measured. The average particle size is the arithmetic mean of the particle sizes of 50 incompatible particles.

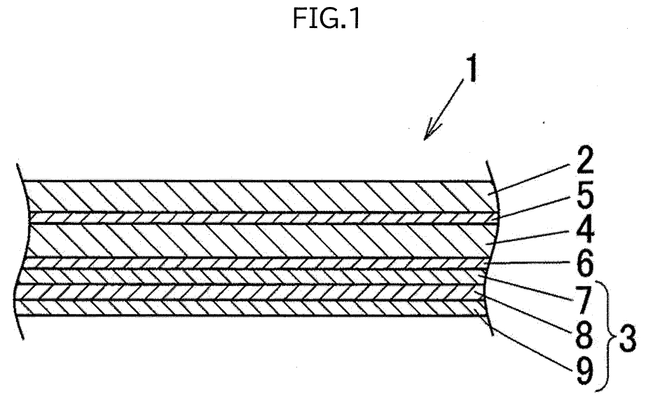

Hereinafter, an example of a packaging material for a power storage device of the present disclosure is shown in FIG. 1. FIG. 1 is a schematic cross-sectional view showing an example of a packaging material for a power storage device of the present disclosure.

A packaging material for a power storage device includes a base layer 2, a barrier layer 4, and sealant layer 3 in this order. The sealant layer 3 includes an A layer 7, a B layer 8 and a C layer 9 when viewed from the barrier layer 4 side. Further, an outer adhesive layer 5 is disposed between the base layer 2 and barrier layer 4, and an inner adhesive layer 6 is disposed between the barrier layer 4 and the A layer 7.

### <Method of Manufacturing Packaging Material for a Power Storage Device>

A method of manufacturing a packaging material for a power storage device is not particularly limited as long as the aforementioned packaging material for a power storage device can be obtained. As an example of a method of manufacturing a packaging material for a power storage device, a method of the packaging material for a power storage device 1 shown in FIG. 1 will be explained below.

A layered body A is prepared in which a base layer 2, an outer adhesive layer 5, and a barrier layer 4 are layered in this order. The layered body A can be produced by a dry laminated method that an adhesive component for forming the outer adhesive layer 5 is applied on the base layer 2 or the barrier layer 4 by the method such as a gravure coating method, or a roll coating method, then it is dried and the barrier layer 4 or the base layer 2 is layered thereon. When the adhesive component is a curable resin, after layering the barrier layer 4 or the base layer 2 on the outer adhesive layer 5, the outer adhesive layer 5 is cured by heating or the like.

Next, the sealant layer 3 is disposed on the barrier layer 4 of the layered body A. The sealant layer 3 may be formed in advance into a resin film and disposed on the barrier layer 4 (first method), or the resin material that forms the sealant layer 3 (propylene resins A to C or resin compositions A to C that contain propylene resins A to C, respectively, as the main components) may be applied onto the barrier layer 4 by extrusion molding, coating, or the like to form the sealant layer 3 (second method).

In the first method, the resin film, which is a multi-layer of the A layer 7, the B layer 8, the C layer 9, and the like, can be produced by a co-extrusion method, or the like.

In the first method, the barrier layer 4 and the sealant layer 3 are bonded together by the inner adhesive layer 6. In the second method, the inner adhesive layer 6 may be omitted or may be disposed.

When the inner adhesive layer 6 is disposed between the barrier layer 4 and the sealant layer 3, the inner adhesive layer 6 and the sealant layer 3 can be layered by an extrusion lamination method, a thermal lamination method, a sandwich lamination method, a dry lamination method, or the like.

Examples of the extrusion lamination method include a method of layering the inner adhesive layer 6 and the sealant layer (A layer 7, B layer 8, and C layer 9) by extruding them onto the barrier layer 4 of the layered body A (co-extrusion lamination method, tandem lamination method), or the like.

Examples of the thermal lamination method include a method of separately forming a layered body B of the inner adhesive layer 6 and the sealant layer 3, and laminating it so that the inner adhesive layer 6 of the layered body B faces the barrier layer 4 of the layered body A, and a method of forming a layered body C with the inner adhesive layer 6 on the barrier layer 4 of the layered body A, and laminating the inner adhesive layer 6 of the layered body C with the sealant layer 3, or the like.

Examples of the sandwich lamination method is a method in which a molten inner adhesive layer 6 is poured between the barrier layer 4 of the layered body A and a sealant layer 3 that has already been formed into a film.

Examples of the dry lamination method is a method in which an adhesive component for forming the inner adhesive layer 6 is solution-coated onto the barrier layer 4 of the layered body A, followed by drying or baking, and then laminating the sealant layer 3, which has already been formed into a film, onto this inner adhesive layer 6.

### <Sealant Film>

A sealant film of the present disclosure includes an A layer, a B layer and a C layer in this order, the A layer contains a propylene resin A, which is a random copolymer of propylene and another copolymer component except for propylene, as a main component, the B layer contains a propylene resin B including a rubber phase, which is a copolymer of ethylene and an α-olefin having 3 to 10 carbon atoms, as a main component, the C layer contains a propylene resin C, which is a random copolymer of propylene and another copolymer component except for propylene, as a main component, a content rate of the rubber phase in the propylene resin B is from 20% by mass to 40% by mass, and the C layer further contains incompatible particles, and a content rate of the incompatible particles in the C layer is from 1000 ppm to 4000 ppm.

A preferable aspect of the sealant film of the present disclosure is the same as a preferable aspect of the packaging material for a power storage device of the present disclosure.

The sealant film of the present disclosure may be used for the manufacture of a packaging material for a power storage device, and for example, may be used for the manufacture of a sealant layer included in a packaging material for a power storage device.

### <Packaging Case for Power Storage Device>

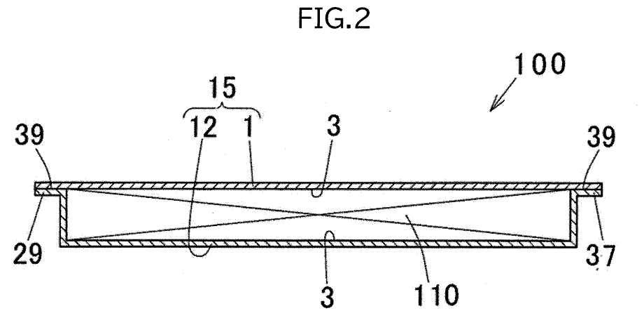

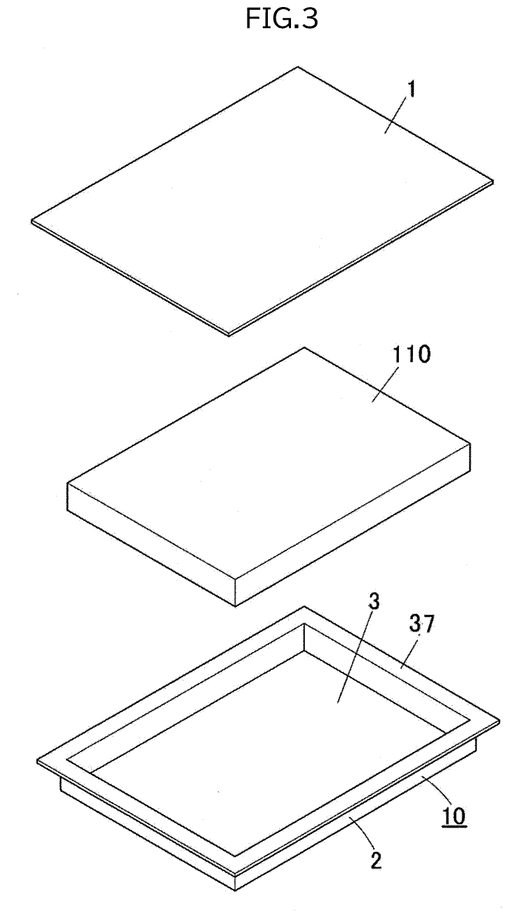

A packaging case for a power storage device of the present disclosure is a molded product of the aforementioned packaging material for a power storage device. The packaging material for a power storage device may be formed by deep drawing, stretch forming, or the like. Examples of the shape of a packaging case for a power storage device include a packaging case 10 shown in FIGS. 2 and 3 described below.

### <Power Storage Device>

A power storage device of the present disclosure includes a power storage device body portion, and a packaging member including the aforementioned packaging material for a power storage device of the present disclosure, which accommodate the power storage device body portion. The packaging member may be configured to include the packaging case for a power storage device of the present disclosure.

An example of a power storage device 100 configured by using the packaging material for a power storage device 1 of the present disclosure is shown in FIGS. 2 and 3. FIG. 2 is a schematic cross-sectional view showing an example of a power storage device. FIG. 3 is a schematic perspective view showing that each component configuring the power storage device in FIG. 2 has been separated.

In FIGS. 2 and 3, a packaging member 15 is composed of a packaging case 10, which is a molded body of a packaging material 1, and the planar packaging material 1. A power storage device body portion 110 is accommodated in the accommodation recess of the packaging case 10. The planar packaging material 1 is then disposed with the sealant layer 3 side facing inward (the lower side in FIGS. 2 and 3), and the peripheral portion of the sealant layer 3 of the planar packaging material 1 and the sealant layer 3 of the flange portion (sealing peripheral portion) 37 of the packaging case 10 are sealed and joined by thermal fusion (heat sealing).

In FIG. 2, reference numeral 39 denotes a heat seal portion at which the peripheral portion of the packaging material 1 and a flange portion (sealing peripheral portion) 37 of the packaging case 10 are joined (welded) to each other. In the power storage device 100, the tip of the tab lead connected to the power storage device body portion 110 is led out to the outside of the packaging member 15, but is not shown in the figure.

The power storage device body portion is not particularly limited and example thereof include a battery body portion, a capacitor body portion, a capacitor (condenser) body portion or the like.

From the viewpoint of reliable sealing, a width of the heat seal portion 39 is preferably adjusted to 0.5 mm or more, and more preferably adjusted to from 3 mm to 15 mm.

The aspect of the packaging member 15 is not limited to that shown in FIGS. 2 and 3, and the edges may be heat-sealed by a pair of planar packaging materials 1, or the edges may be heat-sealed by a pair of packaging cases 10.

### EXAMPLES

Next, examples of the present disclosure will be described, but the present disclosure is not particularly limited to these examples.

### Example 1

A chemical conversion film was formed by applying a chemical conversion treatment solution consisting of phosphoric acid, polyacrylic acid (acrylic resin), a chromium (III) salt compound, water, and alcohol to both sides of an aluminum foil having a thickness of 35 μm, and then drying at 180° C. A chromium deposition amount of the chemical conversion film was 10 mg/m² per one surface.

Next, a biaxially oriented nylon 6 film having a thickness of 15 μm was dry laminated (attached) to one surface of the above-mentioned aluminum foil, on which the chemical conversion treatment was treated, via a two-liquid curing urethane adhesive.

Thereby, a layered body A, in which a base layer, an outer adhesive layer and a barrier layer were layered in this order, was produced.

Next, the following layer A, layer B and layer C were co-extruded using a T-die so that the layers were layered in this order, thereby obtaining a sealant film having a thickness of 30 μm including these three layers.

Layer A: a layer having a thickness of 6 μm and containing a propylene resin A (ethylene-propylene random copolymer), erucamide (lubricant) 1000 ppm and silica particles (average particle size 2.0 μm; incompatible particles) 2000 ppm

Layer B: a layer having a thickness of 18 μm and containing a propylene resin B (ethylene-propylene block copolymer), erucamide (lubricant) 1000 ppm and silica particle (average particle size 2.0 μm; incompatible particles) 50 ppm

Layer C: a thickness of 6 μm and containing a propylene resin C (ethylene-propylene random copolymer), erucamide (lubricant) 1000 ppm and silica particles (average particle size 2.0 μm; incompatible particles) 2000 ppm

An adhesive solution was prepared by mixing 100 parts by mass of maleic acid-modified polypropylene (melting point 80° C., acid value 10 mgKOH/g) as a main ingredient, 8 parts by mass of an isocyanurate of hexamethylene diisocyanate (NCO content rate: 20% by mass) as a curing agent, and a solvent. The adhesive solution was applied to the other side of the aluminum foil so that the solid content was 2 g/m², and after heating and drying, it was superposed on the A layer side of the sealant film. Next, the layered body A was sandwiched between a rubber nip roll and a laminating roll heated to 100° C., and pressure-bonded to dry laminate, and then wound around a roll shaft. After aging (heating) at 40° C. for 10 days, it was pulled out from the roll shaft to obtain a packaging material for a power storage device.

### Examples 2 to 6 and Comparative Examples 1 to 4

A packaging material for a power storage device was obtained in the same manner as in Example 1 except for the thicknesses of the layers A to C, the content rate of the rubber phase of propylene resin B, the average particle size and the content rate of the incompatible particles and the like were changed as shown in Table 1.

### [Heat Seal Evaluation]

### <Seal Strength Measurement>

Two test pieces having 15 mm wide×200 mm long were cut out from the obtained packaging material, and these two test pieces were overlapped so that their inner sealant layers were in contact with each other. In this state, they were heat-sealed by heating on one side using a heat sealing device (TP-701-A) manufactured by Tester Sangyo Co., Ltd. under the conditions of heat sealing temperature: 200° C., sealing pressure: 0.2 MPa (gauge pressure), and sealing time: 2 seconds.

Next, for a pair of packaging materials in which the inner sealant layers were heat-sealed together as described above, the peel strength was measured when the interior sealant layers of the sealed portions of the packaging materials (test pieces) were peeled off at 180 degrees at a tensile speed of 100 mm/min using a Strograph (tensile testing device) (AGS-5kNX) manufactured by Shimadzu Access Co., Ltd., in accordance with JIS K7127-1998, and this was taken as the seal strength (N/15 mm width).

### [Presence or Absence of Air Bubbles]

As shown in FIGS. 2 and 3, a packaging case 10 and a planar packaging material 1 were prepared using a packaging material for a power storage device. Then, a power storage device body portion 110 was accommodated in the accommodation recess of the packaging case 10, and the peripheral portion of the sealant layer 3 of the planar packaging material 1 and the sealant layer 3 of the flange portion (sealing peripheral portion) 37 of the packaging case 10 were sealed and joined by thermal fusion to obtain a power storage device 100. At this time, the conditions were as follows: width of heat seal portion 39: 5 mm, heat seal temperature: 200° C., seal pressure: 0.2 MPa (gauge pressure), seal time: 2 seconds. The power storage device body portion 110 is a lithium ion secondary battery, and uses a mixed solution of ethylene carbonate/propylene carbonate/ethyl propionate/propyl propionate (EC/PC/EP/PP)=Oct. 15, 2010/65 (volume ratio) containing 1.0 M LiPF₆ as the electrolyte solution.

The sealed power storage device 100 was stored in an environment of 85° C. for three days, and then the presence or absence of air bubbles in the heat seal portion 39 was confirmed. Specifically, an optical microscope was used to observe the cross section of the heat seal portion 39, and if there were cavities, it was judged that there were air bubbles, and if there were no cavities, it was judged that there were no air bubbles.

TABLE 1

| | | | | | | | C layer | | | | | |
|---|---|---|---|---|---|---|---|---|---|---|---|---|
| | | | | B layer | | | | Incompatible | | | Evaluation | |
| | | A layer | | Polypropylene | | | | particles | | | Seal | |
| | | Polypro- | Thick- | resin B | | Thick- | Polypro- | Particle | Content | Thick- | strength | Presence or |
| | | pylene | ness | | Rubber | ness | pylene | size | rate | ness | (N/15 | absence of |
| | | resin A | (μm) | Rubber | ratio | (μm) | resin C | (μm) | (ppm) | (μm) | mm) | air bubbles |
| Example | 1 | Random | 6 | Ethylene- | 30 | 18 | Random | 2.0 | 2000 | 6 | 50 | Absence |
| | | copolymer | | propylene | | | copolymer | | | | | |
| | | | | copolymer | | | | | | | | |
| | 2 | Random | 4.5 | Ethylene- | 20 | 21 | Random | 2.0 | 3000 | 4.5 | 46 | Absence |
| | | copolymer | | propylene | | | copolymer | | | | | |
| | | | | copolymer | | | | | | | | |
| | 3 | Random | 7.5 | Ethylene- | 40 | 15 | Random | 2.0 | 2000 | 7.5 | 55 | Absence |
| | | copolymer | | propylene | | | copolymer | | | | | |
| | | | | copolymer | | | | | | | | |
| | 4 | Random | 6 | Ethylene- | 30 | 18 | Random | 4.0 | 2000 | 6 | 50 | Absence |
| | | copolymer | | propylene | | | copolymer | | | | | |
| | | | | copolymer | | | | | | | | |
| | 5 | Random | 6 | Ethylene- | 30 | 18 | Random | 0.5 | 3000 | 6 | 50 | Absence |
| | | copolymer | | propylene | | | copolymer | | | | | |
| | | | | copolymer | | | | | | | | |
| | 6 | Random | 6 | Ethylene- | 30 | 18 | Random | 2.0 | 1000 | 6 | 50 | Absence |
| | | copolymer | | propylene | | | copolymer | | | | | |
| | | | | copolymer | | | | | | | | |
| Compartive | 1 | Random | 6 | Ethylene- | 10 | 18 | Random | 2.0 | 2000 | 6 | 15 | Absence |
| Example | | copolymer | | propylene | | | copolymer | | | | | |
| | | | | copolymer | | | | | | | | |
| | 2 | Random | 4.5 | Ethylene- | 5 | 21 | Random | 5.0 | 3000 | 4.5 | 12 | Presence |
| | | copolymer | | propylene | | | copolymer | | | | | |
| | | | | copolymer | | | | | | | | |
| | 3 | Random | 6 | Ethylene- | 45 | 18 | Random | 1.0 | 500 | 6 | 55 | Presence |
| | | copolymer | | propylene | | | copolymer | | | | | |
| | | | | copolymer | | | | | | | | |
| | 4 | Random | 6 | Ethylene- | 30 | 18 | Random | 4.0 | 5000 | 6 | 50 | Presence |
| | | copolymer | | propylene | | | copolymer | | | | | |
| | | | | copolymer | | | | | | | | |

As shown in Table 1, in the packaging material for a power storage of each of Examples 1 to 6, the seal strength was improved and the occurrence of air bubbles was suppressed.

1. A packaging material for a power storage device comprising a base layer, a barrier layer, and a sealant layer configured to be layered in this order,
wherein the sealant layer comprises an A layer, a B layer and a C layer when viewed from the base layer side,
wherein the A layer comprises a propylene resin A, which is a random copolymer of propylene and another copolymer component except for propylene, as a main component,
wherein the B layer comprises a propylene resin B comprising a rubber phase, which is a copolymer of ethylene and an α-olefin having 3 to 10 carbon atoms, as a main component,
wherein the C layer comprises a propylene resin C, which is a random copolymer of propylene and another copolymer component except for propylene, as a main component,
wherein a content rate of the rubber phase in the propylene resin B is from 20% by mass to 40% by mass, and
wherein the C layer further comprises incompatible particles, and a content rate of the incompatible particles in the C layer is from 1000 ppm to 4000 ppm.

2. The packaging material for a power storage device according to claim 1, wherein a ratio of a thickness of the B layer with respect to a thickness of the sealant layer is 50% or more.

3. The packaging material for a power storage device according to claim 1, wherein the incompatible particles comprises silica particles.

4. A sealant film, comprising an A layer, a B layer and a C layer in this order,
wherein the A layer comprises a propylene resin A, which is a random copolymer of propylene and another copolymer component except for propylene, as a main component,
wherein the B layer comprises a propylene resin B comprising a rubber phase, which is a copolymer of ethylene and an α-olefin having 3 to 10 carbon atoms, as a main component,
wherein the C layer comprises a propylene resin C, which is a random copolymer of propylene and another copolymer component except for propylene, as a main component,
wherein a content rate of the rubber phase in the propylene resin B is from 20% by mass to 40% by mass, and
wherein the C layer further comprises incompatible particles, and a content rate of the incompatible particles in the C layer is from 1000 ppm to 4000 ppm.

5. The sealant film according to claim 4 used for a manufacture of a packaging material for a power storage device.

6. A packaging case for a power storage device comprising a molded product of the packaging material for a power storage device according to claim 1.

7. A power storage device comprising:
a power storage device body portion, and
a packaging member comprising the packaging material for a power storage device according to claim 1, which accommodate the power storage device body portion.
